(19) United States
(12) Patent Application Publication
(10) Pub. No.: US 2010/0102467 A1
(43) Pub. Date: Apr. 29, 2010

(54) POLYMER UNDERWATER MELT CUTTER AND PROCESSES ASSOCIATED THEREWITH

(75) Inventors: Marion Glen Waggoner, Landenberg, PA (US); David Neil Marks, Newark, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/582,741

(22) Filed: Oct. 21, 2009

Related U.S. Application Data
(60) Provisional application No. 61/197,655, filed on Oct. 28, 2008.

(51) Int. Cl. B29B 9/10

(52) U.S. Cl. 264/12; 425/7

(57) ABSTRACT

In an improved polymer melt cutter a gas is added to the cooling liquid before the cooling liquid enters the cutting chamber, or is added directly through the cutting chamber wall. This forms a cooling liquid/gas mixture in the cutting chamber, which has the advantage of providing easier startups, lower operating costs, and other advantages. Processes associated with the improved polymer melt cutter are also disclosed.

### CROSS REFERENCE TO RELATED APPLICATIONS

This application claims the benefit of U.S. Provisional Application No. 61/197,655, filed Oct. 28, 2007, which is incorporated herein by reference in its entirety.

### FIELD OF THE INVENTION

A polymer melt cutter has easier startups, and/or the temperature of the pelletized product may be controlled, by mixing a gas with the cooling liquid.

### BACKGROUND OF THE INVENTION

Thermoplastics (TPs) are very important items of commerce. Typically they are formed into various parts and shapes by melt forming, that is melting of the TP, forming it while molten into a shape and then cooling the TP to a solid to “fix” it in that shape. In most melt forming machines, the TP is fed in the form of a pellet or granule, typically in the size range of 0.1 to about 0.7 cm (longest dimension). In order for most melt forming machines to work efficiently, it is preferred that the pellets or granules be free flowing and have a reasonably uniform size.

Many types of apparatuses have been developed to pelletize TPs. Such an apparatus should preferably produce uniform and readily flowing pellets, at low cost. One such type of pelletizing apparatus is the so-called “underwater melt cutter” (UMC, sometimes also called an “underwater pelletizer”), see for instance U.S. Pat. Nos. 2,918,701 and 3,749,539. When a UMC is operating properly, it is capable of producing large amounts of TP pellets which are uniform and free flowing. However, UMCs have a number of drawbacks, among these difficulty in pelletizing higher melting point (>200° C.) TPs or TPs that otherwise readily freeze to solids, intolerance to process upsets such as short interruptions in polymer flows, and sometimes difficult startups. Since the cooling liquid (since water is by far the most commonly used liquid, herein cooling liquid and water are used interchangeably) for UMCs is usually water, the polymer being pelletized may absorb some of that water, often a problem with polymers that absorb water readily and/or hydrolyze in the presence of water, especially in a melt forming machine such as an extruder or injection molding machine. As stated in the Encyclopedia of Polymer Science and Technology, Vol. 2, John Wiley & Sons, New York, p. 518, “The start-up procedure for underwater pelletizers often requires careful sequencing of plastic flow, cutter rotation, and inlet water flow rate to avoid die freeze-off or agglomeration.” Thus it would be desirable to have improved UMCs that would minimize these and other difficulties with UMCs.

U.S. Pat. No. 7,157,032 describes underwater melt cutting processes in which air is injected into the polymer pellet/water stream after this stream has left the cutting chamber. Nothing is said of introducing a gas into the cutting chamber.

Japanese Patent Application 69007143 describes a pelletizing apparatus which has a gas “layer” over the die face to reduce cooling of the die.

### SUMMARY OF THE INVENTION

There is disclosed and claimed herein a melt cutter which comprises a die having an exit face and one or more die holes through which molten polymer is fed and exits said die hole at said exit face, and a rotary cutter head having one or more blades which cut said polymer as it emerges from said die holes, said exit face and said rotary cutter being in and/or a part of a cutting chamber which is filled with a cooling liquid which cools said molten polymer to solidify said molten polymer, and wherein said cooling liquid flows through said chamber, wherein the improvement comprises, introducing into said cooling liquid a gas which forms a mixture with said cooling liquid, said mixture is in contact with said exit face, and wherein said gas is about 2 to about 70 percent by volume of the total volume of gas and cooling liquid entering said chamber.

This invention also comprises a process for pelletizing a polymer, and a process for starting up an melt pelletizer, using the UMC described immediately above.

### BRIEF DESCRIPTION OF THE DRAWING

FIG. 1 is a cross section of a cutting chamber of an UMC in which gas is added to the cooling liquid inlet pipe.

### DETAILED DESCRIPTION OF THE INVENTION

Herein certain terms are used, and some of them are defined below:

By “exit face” (of the die) is meant the face or surface that the polymer last exits into the cooling medium. The exit face may include the exit face of the die body itself, a thermally insulating part put over the die body to keep it from losing heat, a hard surfaced material on top of the die body to prevent wear of the die body by the rotating knives, any combination of these, etc. Typically the rotating knives will contact the exit face, or have very little clearance from the exit face, so that the molten, but cooling, polymer exiting the exit face is cut off cleanly by the knife.

By “rotary cutter head” is meant a cutter head having one or more knives attached, the head rotating while in operation. The knife(ves) rotate against or very close to the exit face so that the polymer exiting die assembly is cut off cleanly. Normally the axis of rotation of the cutter head is at right angles to the surface of the exit face. The chamber may enclose all of the internal components such as the exit face and part of the die assembly and the cutter head, or one or more of these components such as the die near the exit face may form part of the outer part(s) of the chamber.

By a “cutting chamber” is meant a volume that contains the rotary cutter head and the exit face of the die assembly, and which normally has an inlet and outlet for cooling liquid, usually water. In operation the cooling liquid flows through the chamber at a rate high enough to cool the molten polymer exiting the die assembly, and to convey the resulting pellets out of the chamber. In a preferred embodiment the cooling liquid is water.

By “reverse taper die holes” is meant that the die hole at the (polymer) exit side of the die plate is wider in diameter than along the rest of the die hole and tapers to a smaller size hole as one goes from the exit face of the die plate towards the (polymer) entrance face of the die plate. These die holes need not taper throughout the length of the die hole, but must taper on the die plate exit side. Typically the depth of the taper will be at least about 0.5 cm to about 5 cm. By “depth of taper” is meant the length along the axis of the hole of the reverse tapered section. The tapered portion has a “taper angle” (for a definition of a “taper angle”, see US Published Patent Application 20050140044, which is hereby included by reference). While not critical it is preferred that the taper angle is at least 0.1°, more preferably at least about 0.2°, especially preferably at least about 0.5°, and very preferably at least about 1.0°. It is also preferred that the taper angle is about 10° or less, more preferably 5° or less, and especially preferably about 4.0° or less. It is to be understood that any minimum and maximum taper angles given above may be combined to give a preferred taper angle range. The presence of (a) reverse taper die hole(s) is especially preferred when the present invention is used as a process for startup of the UMC.

It is believed the “effective thermal conductivity” of the cooling liquid mixed with gas is lowered, probably by two mechanisms. The heat capacity of the overall flow of the gas and liquid is lower, and the thermal conductivity of virtually all gases is lower than that of virtually all liquids. This means that the heat loss from the molten polymer exiting from the exit face of the die is lower, and heat loss from the exit face of the die (including whatever may be covering the die body, such as a thermal insulator, hard face to prevent wear on the actual die face, etc.) to the cooling liquid is also lower. This is particularly important on startup of the UMC, especially if there is solidified residual polymer in the die holes or other parts of the die assembly.

In previous UMCs, typically on startup this residual polymer is solid and must be softened, preferably melted, to go through the die. Thus for a startup the die is heated, usually by an internal heating means and/or external heating means, to melt or soften the polymer. Then in rapid succession the rotary cutter is turned on, the cooling liquid flow is started, and the polymer flow is started, for example by pumping molten polymer (the polymer flow may be started before the coolant flow, but this may cause other problem such as agglomeration of the cut polymer in the cutting chamber). This must be done rapidly in order that the material before the die holes, and the polymer in the die holes or that flows into the die holes does not cool down enough to freeze the polymer. This is because when the cooling liquid (water) is turned on it rapidly cools the exit face of the die, which of course by thermal conduction also cools the more interior parts of the die, including the die hole surfaces. However if a mixture of cooling liquid and a gas is used, the effective thermal conductivity of the cooling liquid is reduced, so that the exit face of the die, and hence the die body, is not cooled as rapidly, therefore giving more leeway in the startup procedure.

Even more preferably the cooling liquid and gas flows may be turned on while the die is being heated or after the die has been heated for a while, and then when the polymer in the die holes is melted or softened with the cooling liquid and gas flowing, starting the rotary cutter head, and then the polymer is forced (pumped by whatever means is normally used) through the die holes. This has the advantage of no critical timing on the startup steps of heating, turning on the cooling liquid, and starting the polymer flowing, etc., and in fact may not require opening of the coolant chamber to clean out any polymer from the die holes or from the die exit face, a timesaving and a safety advantage.

For these startup procedures mentioned above it is preferred that the die holes be reverse taper die holes, and/or there be a thermally conductive path from a heat source in the die body to the surface of the die holes which contact the polymer as it flows through the die holes. By a “thermally conductive path” is meant that between the heat source and the die hole surface the materials of construction have a thermal conductivity of at least about 30 W/mK, more preferably at least about 50 W/mK. Between different parts of this thermally conductive path there may be very narrow gaps, such as air gaps because of the impossibility of getting perfect fits between parts. For more information about reverse taper die holes and thermally conductive paths see US Published Patent Application 20050140044. The heating of the die body and die itself may be done by any of the usual sources, such as electrical heaters, hot oil, or steam.

In the startup it is preferred that after the die has been heated for a while the cooling liquid and gas are turned on and the die allowed to come to approximate equilibrium, and/or the polymer in the die holes is melted or softened. This may typically take 1 to 30 minutes, depending on a variety of factors such as the initial temperature of the die body, the melting or softening point of the polymer, the amount of thermal energy which can be transferred to the die body (in other words the capacity of the heating system), the flow rate of the gas and cooling liquid, and other factors. For determining what a routine startup condition should be, these and other factors are readily determined.

Similarly once the UMC is started up the mixture of cooling liquid (water) and gas also has advantages over cooling liquid alone. Again since the effective thermal conductivity of the cooling liquid-gas mixture is less than that of cooling liquid alone, the pellets produced in the process will be warmer than those produced using water alone. Indeed the temperature of the pellets as they exit the apparatus may be controlled to some extent by varying the cooling liquid:gas volumetric ratio. The higher the relative amount of gas used, the warmer will be the pellets. Sometimes it is desirable to keep the pellets as warm as possible (without agglomeration of the pellets), so that the pellets will have a low residual water content when packaged.

When a semicrystalline thermoplastic is being cut it may also be advantageous to keep the pellets warmer in order to promote crystallization of the polymer, if that is desired, see for instance U.S. Pat. No. 7,157,032, which is hereby included by reference.

Another advantage of using the cooling liquid/gas mixture in routine operation is that since the effective thermal conductivity of the cooling liquid/gas mixture is lower than that of cooling liquid alone, less heat is lost from the exit surface of the die, and hence the die itself, using the cooling liquid/gas mixture. Thus less power (for example electricity for electrical heaters) is needed to heat the die body than when cooling liquid is used alone.

Another potential energy savings is the power needed to run the rotary cutter head motor, which of course turns the cutter head. Because the polymer exiting the die exit surface is not cooled as rapidly when a water/gas mixture is used, solidification of the polymer is slower, and therefore it is believed the knives may cut through the polymer more easily than if all water is used. Also the effective viscosity of the cooling liquid/gas mixture may be lower than cooling liquid alone. Because of these two factors, power consumption by the cutter head motor may be significantly decreased.

Any gas may be used, so long as it is inert towards the polymer and equipment under the process conditions. Useful gases include air, nitrogen, argon, carbon dioxide, and air is preferred. The volume of gas is about 2 to 70% by volume of the total volume of gas and cooling liquid entering the cutting chamber. The volume percent of the gas (of the total volume of gas and cooling liquid) used is a minimum of 2%, preferably about 5%, more preferably about 10%, and most preferably about 20%, and the maximum volume percent of the gas is about 70%, preferably about 60%, more preferably about 50%, and most preferably about 40%. The amount of gas added should not be so high that the polymer pellets being formed are not carried along in the gas and cooling liquid stream exiting the cutting chamber.

The gas may be added to the cooling liquid line which carries the cooling liquid to the cutting chamber or to the cutting chamber itself. No special nozzle is needed to add the gas to the system, since the rotary cutter head, which during operation is spinning at high speed, acts as an efficient mixture to keep the cooling liquid/gas mixture well mixed and the gas as relatively small bubbles in the cutting chamber.

It may be advantageous to have flow meters and/or metering valves, and/or check valves on the gas and/or water lines in order to be able to control and monitor the absolute and relative flows of the cooling liquid and/or gas, and (optionally) to prevent backflow of the water into the gas line and gas back into the cooling liquid line. These metering valves may be automated (for example computer controlled) to provide the desired absolute and relative flows of gas and/or cooling liquid.

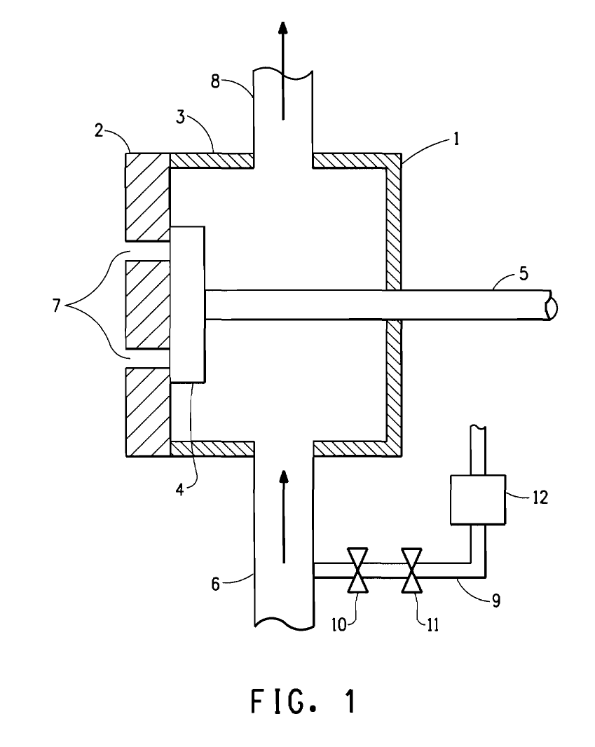

FIG. 1 shows a cross section of such a system in which the gas is added to the cooling liquid inlet line (in this figure items such as attachments, pipe threads, heaters, thermocouples, etc. are omitted). In FIG. 1, cutting chamber 1 is shown, and one side of the cutting chamber is formed by die block 2 which has a die exit face 3. The die block 2 has die holes 7. Holding knives (not shown) against 3 is rotary cutter head 4 which is attached to shaft 5, which in turn is attached to a motor (not shown) which turns 5. Cooling liquid flows through inlet cooling liquid line 6 (direction of cooling liquid flow is shown), through the cutting chamber 1, and out through outlet cooling liquid line 8 (direction of flow is shown). Attached to inlet cooling liquid line 6 is gas (air) line 9 , which has in the line an optional flow control valve 10, an optional check valve 11, and an optional flow meter 12. It is to be understood that items analogous to 10, 11, and/or 12 may also be present in inlet cooling liquid line 6, especially before (in flow terms) the junction of 6 and 8. In another configuration gas line 9 could have been connected directly to cutting chamber 1, so that the gas flowed directly into the cutting chamber.

Preferably the gas is added to the cutter apparatus either in the inlet cooling liquid line (such as 6) and/or through the cutting chamber (such as 1) wall. Whether the gas is added to the inlet cooling liquid line 6 and/or directly to the cutting chamber 1, the action of the rotary cutter head 4 disperses the gas into the liquid cooling medium. Thus the cutting chamber contains a mixture of gas and cooling liquid, with the gas dispersed in the cooling medium as bubbles. This mixture contacts the interior of the cutting chamber (1), the rotary cutter head (4), and the die exit face (3).

For the startup process for the UMC, it is preferred that the gas be flowing at least 1 minute, more preferably at least 2 minutes, and especially preferably at least 5 minutes before the polymer flow is started. As noted in Example 1, if the polymer flow is started immediately after the gas is turned on, the good effect of the gas in easing the startup may not be apparent.

### Example 1

The melt cutter used was a Gala Model 6 underwater pelletizer (Gala Industries, Inc., Eagle Rock, Va. 24085, USA), in conjunction with a Gala Model 8.1 spin dryer. The melt cutter was fed by a gear pump at the rate of 56.7 kg/h (125 lb/h). In turn the gear pump was fed by a 57 mm Werner & Pfleiderer twin screw extruder, which melted the polymer composition. The die feeding the pelletizer was a single hole die (for test purposes all the other holes were blocked off). This die hole had an insert which had an inner diameter (hole) which was 3.68 mm (0.145 in) in diameter, which flared out towards the die exit face to a final diameter of 4.27 mm (0.168″). This corresponds to a total flare angle of 4.0°, since the flared section was 8.35 mm long. On the exit face of the die was a thin layer of mica, and on top of the mica was a hard face. The die hole insert protruded through to the outer surface of the mica. The hard face material has a die hole that was reverse tapered with a 3.0° taper angle.

Attached to the water inlet pipe (the setup is somewhat analogous to FIG. 1), just before the cutting chamber was a 0.64 cm (0.25 in) ID pipe for injecting air. In the air line was a supply regulator which was set to 137 kPa (gauge), and there was a flow meter in the air line. The water supply pump for the pelletizer had a nominal flow rate of about 0.19 m³/min. The flow of air was regulated to provide a desired flow rate of gas through the cutting chamber.

The polymer composition tested was the same described in U.S. Pat. No. 5,110,896 as LCP-4. This polymer has a melting point of about 335° C. The polymer melt temperature was about 360° C. The polymer was pumped by the gear pump at a rate of 56.7 kg/h. In all tests, except as noted, the die temperature was allowed to come to equilibrium as indicated by the percentage of time the die heaters were on.

A series of startup tests, in which the die hole contained solidified polymer, were run under varying conditions, in which the die temperature, percent air in the cooling liquid, and waiting time before starting the gear pump (polymer flow) were varied. The maximum pressure recorded after the pump was turned on was noted. The lower this pressure was, the easier it was to open the hole to polymer flow. In all tests the water temperature flowing to the cutter was 60° C.

Without any air flow, and a die temperature of 380° C., and a rotary cutter speed of 3400 rpm the maximum pressure recorded was 5.31 MPa. Under the same conditions, when the air flow was 40 volume percent of the total of the air and water, and the test was started immediately after the air flow was turned on the results were the same, except the amount of electric current needed to turn the rotary cutter head was reduced by about 33%.

When this test with the 32 volume percent air was repeated, except that the pump was not turned on until after 5 minutes had elapsed after the air had been turned on, the maximum pressure recorded was 1.38 MPa, a considerable reduction over that recorded with no air flowing.

The tests were repeated with a die temperature of 360° C. With no air flowing the maximum pressure was 6.14 MPa, while with 32 volume percent air and a wait time of 5 minutes the maximum pressure was 3.45 MPa.

In all these tests, whether air was flowing or not, after the hole was opened and polymer flowed, there was no discernable difference in the pellets or the back pressure on the die. Operation was stable and there were no unusual vibrations in the apparatus as polymer was flowing, whether the air flow was on or not.

What is claimed is:

1. A melt cutter which comprises a die having an exit face and one or more die holes through which molten polymer is fed and exits said die hole at said exit face, and a rotary cutter head having one or more blades which cut said polymer as it emerges from said die holes, said exit face and said rotary cutter being in and/or a part of a cutting chamber which is filled with a cooling liquid which cools said molten polymer to solidify said molten polymer, and wherein said cooling liquid flows through said chamber, wherein the improvement comprises, introducing into said cooling liquid a gas which forms a mixture with said cooling liquid, said mixture is in contact with said exit face, and wherein said gas is about 2 to about 70 percent by volume of the total volume of gas and cooling liquid entering said cutting chamber.

2. A process for pelletizing a polymer using a melt cutter which comprises a die having an exit face and one or more die holes through which molten polymer is fed and exits said die hole at said exit face, and a rotary cutter head having one or more blades which cut said polymer as it emerges from said die holes, said exit face and said rotary cutter being in and/or a part of a cutting chamber which is filled with a cooling liquid which cools said molten polymer to solidify said molten polymer, and wherein said cooling liquid flows through said chamber, wherein the improvement comprises, introducing into said cooling liquid a gas which forms a mixture with said cooling liquid, said mixture is in contact with said exit face, and wherein said gas is about 2 to about 70 percent by volume of the total volume of gas and cooling liquid entering said cutting chamber.

3. The process of claim 2 wherein said cooling liquid is water.

4. The process of claim 2 wherein said gas is air.

5. A process for the startup of a melt cutter which comprises a die having an exit face and one or more die holes through which molten polymer is fed and exits said die hole at said exit face, and a rotary cutter head having one or more blades which cut said polymer as it emerges from said die holes, said exit face and said rotary cutter being in and/or a part of a cutting chamber which is filled with a cooling liquid which cools said molten polymer to solidify said molten polymer, wherein said cooling liquid flows through said chamber, and wherein said polymer is melted or softened by heating said die, wherein the improvement comprises, before starting a polymer flow in said melt cutter, introducing into said cooling liquid a gas which forms a mixture with said cooling liquid, said mixture is in contact with said exit face, and wherein said gas is about 2 to about 70 percent by volume of the total volume of gas and cooling liquid entering said cutting chamber.

6. The process of claim 5 wherein the cooling liquid is water.

7. The process of claim 5 wherein the gas is air.
